(19) United States
(12) Patent Application Publication
(10) Pub. No.: US 2005/0104455 A1
(43) Pub. Date: May 19, 2005

(54) Electrically operated actuator provided with rocking arm

(75) Inventor: Luciano Migliori, Milan (IT)

Correspondence Address: YOUNG & THOMPSON, 745 SOUTH 23RD STREET, 2ND FLOOR, ARLINGTON, VA, 22202, US

(73) Assignee: UNIVER S.P.A., MILAN (IT)

(21) Appl. No.: 10/989,253

(22) Filed: Nov. 17, 2004

(30) Foreign Application Priority Data
Nov. 17, 2003 (IT) MI2003A 002227
Jun. 10, 2004 (IT) MI2004A 001157

(51) Int. Cl. H02K 41/00

(52) U.S. Cl. 310/12

(57) ABSTRACT

An electrically operated actuator includes a box-shaped body to which an angularly movable rocking arm is pivotally connected; the actuator also includes control elements operatively connected to the rocking arm by a toggle-lever mechanism, the control elements in turn having at least one electric motor, and a connecting screw-nut mechanism. The actuator further includes a position transducer device of rotary and absolute type, providing reference signals univocally related to the angular positions of the rocking arm, and a programmable electronic control unit and self-braking elements for the electric motor, the control unit being programmed to control the angular rotation of the rocking arm and to actuate the self-braking elements for the electric motor, in relation to the control signals provided by the absolute transducer device.

### BACKGROUND OF THE INVENTION

This invention concerns an electrically operated actuator provided with a rocking work arm, used in particular in the manufacture of motor vehicles for operating angularly movable structures or handling equipments provided with a plurality of clamping and/or centering devices for clamping and/or centering work pieces or metal sheets of bodyworks to be assembled, or for other similar uses.

### STATE OF THE ART

Pneumatic actuators having a rocking arm are commonly known, which are used for example in the automotive manufacturing field, along bodywork assembling lines, to move handling equipments or supporting structures for a plurality of clamping and/or centering devices.

An actuator of this type, known for example from EP 1 300 625, generally comprises a box-shaped body to which a work arm is pivotally connected, said work arm being angularly movable between a first and a second operative position; the actuator further comprises linear drive means operatively connected to the work arm by means of a toggle-lever mechanism housed in the box-shaped body of the actuator.

The drive means in turn comprise a pneumatic cylinder, supported by the box-shaped body of the actuator, having an axially movable piston rod connected to the aforesaid toggle-lever mechanism for controlling the work arm.

The use of pneumatic control means however involves several functional problems, in that the use of a compressible fluid such as pressurised air does not allow a precise control of the position and the movement of the work arm, and in addition involves a possible onset of vibrations and oscillations of the same work arm, which induce overstress in the actuator.

Moreover, as regards plant problems, it is necessary to provide suitable production and distribution systems for the pressurised air to the different actuators installed along the assembling lines, with a consequent increase in the costs and complexity of the same lines.

A further problem is that pneumatically operated actuators are extremely noisy, especially during discharge of the air from the cylinder, and are liable to constitute a source of environmental pollution due also to atomisation into the atmosphere of the lubricants often contained in industrial pressurised air.

Furthermore, in general, conventional type actuators do not offer the possibility of simple and accurate adjustment and control of the work arm movement, in particular during the transient states of starting up and stopping, in that it is only possible to establish in advance the motion angle of the arm by means of complex mechanical operations for adjusting the actuators.

Another drawback of such actuators is that they can't be manually operated, causing some control end safety problems, in that, in case of faults of the control means, the supporting structure connected to the work arm control could result in a dangerous position, without any possibility of intervention.

Therefore, the need exists for an actuator enabling accurate control of the position and movement of the work arm, the actuator at the same time allowing to eliminate parasitic vibrations and oscillations of the same work arm and to substantially simplificate the plants end systems necessary for its operation.

### OBJECTS OF THE INVENTION

The main object of this invention is to provide an actuator provided with a rocking work arm, enabling a precise control of the position and of the movement of the work arm, eliminating parasitic vibrations and oscillations of the same work arm.

A further object of this invention is to provide an actuator of the aforementioned type, which is structurally simple and inexpensive, and which allows to limit the costs and complexity of the systems dedicated to its operation.

A still further object of this invention is to provide an actuator of the aforementioned type, which produces limited noise and no emissions of pollutant substances, thereby contributing to an improvement of the quality of the work environment.

Still another object of this invention is to provide an actuator of the aforementioned type, whereby it is possible to detect the position of the work arm under any operating condition, also in the event of accidental interruption of the power supply.

A further object of this invention is to provide an actuator of the aforementioned type, whereby it is possible to block the rocking work arm, without the use of any dedicated blocking device.

A still further object of this invention is to provide an actuator of the aforementioned type, which can be manually operated, thereby allowing the possibility of controlling the work arm movement in case of faults of the control means.

### BRIEF DESCRIPTION OF THE INVENTION

The foregoing can be achieved by means of an electrically operated actuator having a rocking arm for operating an angularly movable supporting structure for a plurality of clamping and/or centering devices, of the type comprising:
a box-shaped body;
at least one angularly movable rocking arm, pivotally supported by said box-shaped body; and
control means having a toggle-lever mechanism operatively connected to the rocking arm;
said control means comprising:
at least one electric motor;
a screw-nut mechanism operatively connected between the toggle-lever mechanism and the electric motor; and
a position transducer device of rotary and absolute type, operatively connected to said screw-nut mechanism, said transducer device being conformed to provide reference signals univocally related to the angular positions of the rocking arm;
programmable electronic control unit and self-braking means for the electric motor being provided, said control unit being programmed to control the angular rotation of the rocking arm and to actuate the self-braking means for the electric motor, in relation to the control signals provided by the absolute transducer device.

### BRIEF DESCRIPTION OF THE DRAWINGS

These and further features according to this invention, will be more clearly evident from the following description with reference to the accompanying drawings, in which:

FIG. 1 shows a front view of an actuator having a rocking oscillating rocking arm according to the invention;

FIG. 2 shows a longitudinal cross-sectional view of the actuator of FIG. 1, with the rocking arm in correspondence with a first operative position;

FIG. 3 shows a longitudinal cross-sectional view of the actuator of FIG. 1, with the rocking arm in correspondence with a second operative position;

FIG. 4 shows an enlarged detail of FIG. 2;

FIG. 5 shows a cross-sectional view of the actuator of FIG. 2 along the line 5-5;

FIG. 6 schematically shows the first gear unit for connection between the screw-lead mechanism and the electric actuating motor;

FIG. 7 shows an enlarged detail of the second gear unit of FIG. 5;

FIG. 8 shows a block diagram illustrating the control system of the electric motor.

### DETAILED DESCRIPTION OF THE INVENTION

The general features of this invention will be illustrated hereunder by means of a preferred embodiment.

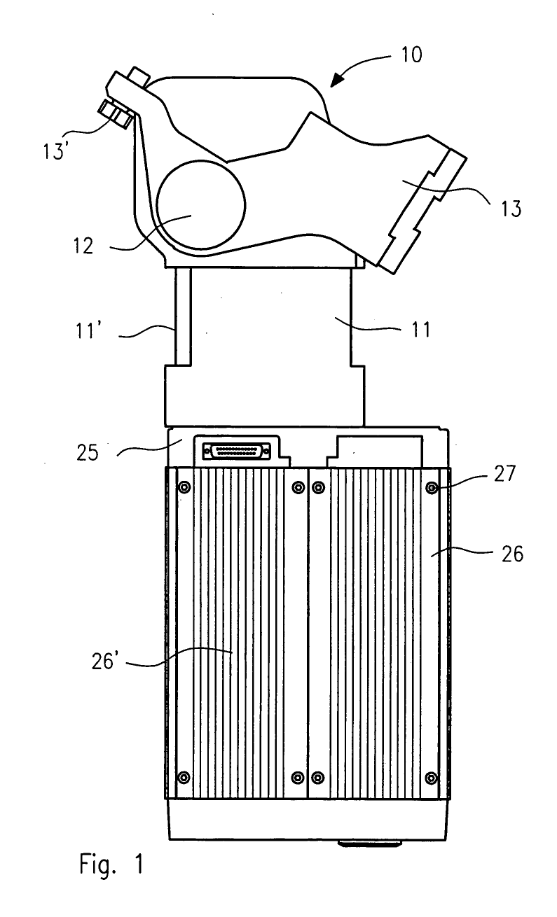

The FIGS. 1 to 7 show an electrically operated actuator having a rocking arm according to the invention, for operating an angularly movable supporting structure provided with a plurality of clamping and/or centering devices for workpieces.

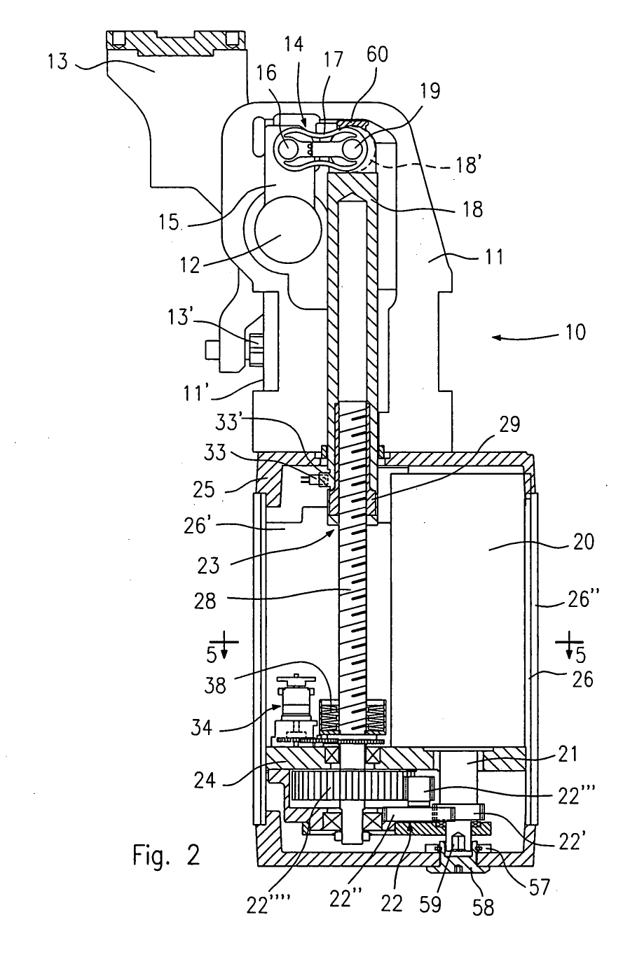

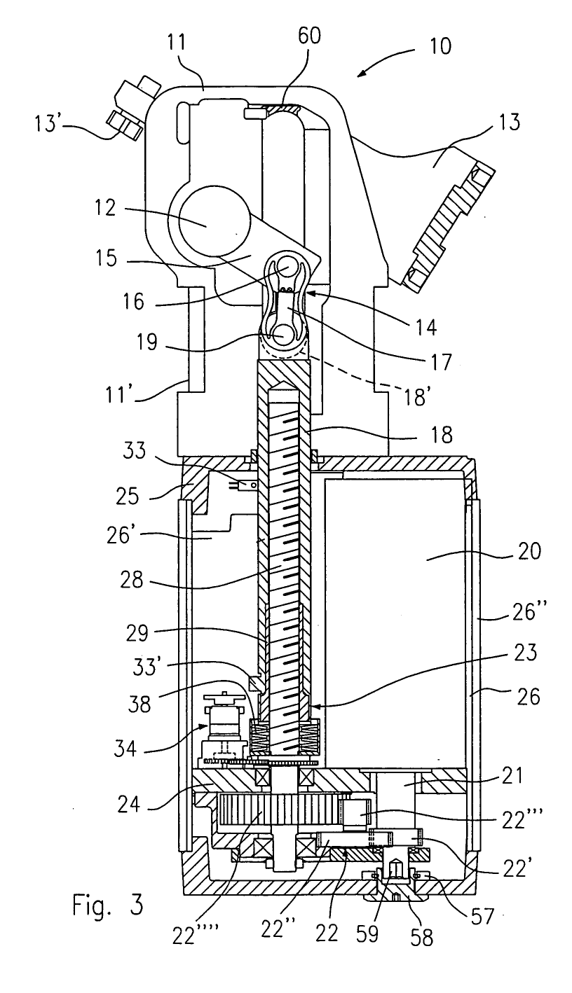

In particular, as illustrated in FIGS. 2 and 3, the actuator, indicated as a whole by reference 10, comprises a box-shaped body 11, which supports, by a pivotal axis 12, at least one rocking arm 13 angularly movable between a first and a second operative position.

The actuator 10 also comprises linear control means operatively connected with the rocking arm 13 by means of a toggle-lever mechanism 14 housed in the box-shaped body 11.

The toggle-lever mechanism 14 in particular comprises a crank 15, pivotally connected to the axis 12 and movable in rotation with the rocking arm 13, the crank 15 being connected with an intermediate connecting link 17 by a hinge axis 16; the intermediate link 17 in turn is connected with the linear control means by means of a hinge axis 19.

The intermediate connecting link 17 is preferentially of the elastically yieldable type, configured to be yieldable in to the longitudinal direction of the same connecting link 17; the connecting link 17 comprises a first and a second pivoting ends connected together by two side arms elastically yielding in an axial direction, the pivoting ends also comprising respective spaced apart stop means arranged to limit the axial compression of the same connecting link 17, upon reaching and overcoming a dead centre condition of the toggle-lever mechanism 14.

The control means of the actuator comprise at least one electric actuating motor 20, in this case one, having a drive shaft 21, which is operatively connected with an axially extensible screw-nut screw mechanism 23, by a first gear transmission unit 22.

The screw-nut mechanism 23 in turn comprises an axially sliding thrust member 18, operatively connected with the toggle-lever mechanism 14; in particular the thrust member 18, which comprises guide rollers 18′ for sliding along the box-shaped body 11, is extendable in an axial direction parallel to the electric motor drive shaft 21, between a first forward position and a second backward position, corresponding to an extended condition, and respectively a contracted condition of the screw-nut mechanism 23.

The electric actuating motor 20 is preferentially of the step type, which possesses optimal characteristics for the actuator 10 according to this invention; in particular, the step motor has high torque values at a low number of revolutions, and, when it is at a standstill and without power supply, it has a residual torque which can be used as a motor brake.

The aforesaid residual torque at a standstill can also be increased by short-circuiting the windings; therefore, the step motor develops a high static braking action which could otherwise be obtained exclusively by introducing a separate braking system into the actuator, with consequent greater structural complexity and higher cost.

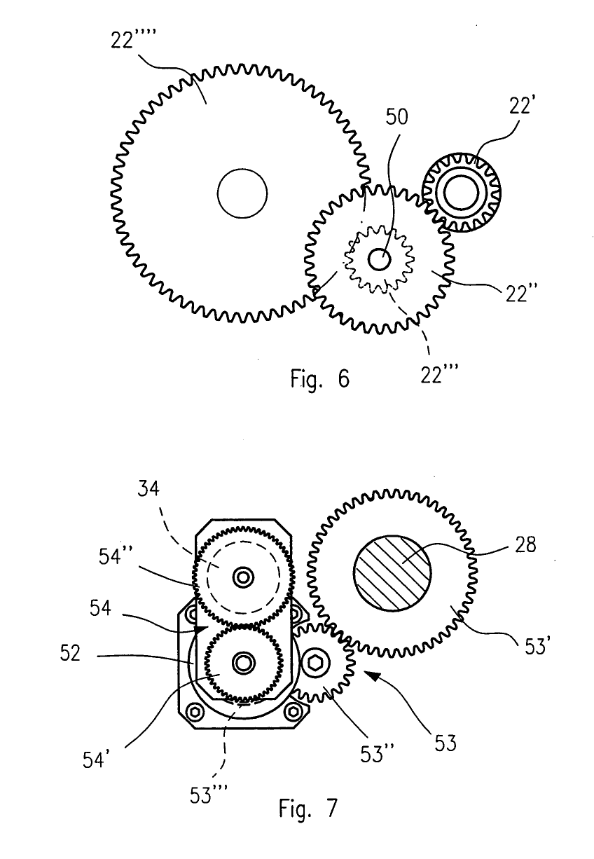

As shown in the FIGS. 4 and 6, the first gear unit 22 preferentially comprises a first gear 22′ coaxially mounted onto the drive shaft 21, connected to a second gear 22″ mounted onto an intermediate shaft 50, onto which is also mounted a third gear 22′″, in turn connected with a fourth gear 22″″ mounted onto the screw-nut mechanism 23; in this way it is possible to vary the transmission ratio within a wide range of values.

Preferentially, the first gear unit 22 provides a gear reduction ratio of the step motor rotation comprised between 1/5 and 1/9, in such a way that it is possible to provide an easy manual operation of the actuator 10 by using an appropriate wrench directly on the drive shaft 21 of the motor 20, furthermore, in this way the braking torque exerted by the motor 20 is sufficiently geared up to enable the braking of the actuator 10, without any further braking system.

Preferentially, the control means 20, 22, 23 are removably secured as a single unit to the box-shaped body 11, in such a way to allow a simple and fast replacement of the same control means in case of faults. In particular, the control means 20, 22, 23 are secured to a removable support frame 24 which in turn is removably secured to a base frame 25 at the bottom of the box-shaped body 11 by a plurality of removable side plates 26 connecting the support frame 24 and the base frame 25.

The base frame 25 can be a separate part removably connected to the box-shaped body 11, for example by suitable screw means.

As shown in FIG. 1, preferentially the side plates 26 are removably secured to the supporting frame 24 and to the base frame 25 by screw means 27 which engage in suitable side holes in the frames 24 and 25.

The side plates 26 define a housing 26′ for the control means 20, 22, 23, and can be individually removed, so as to be able to selectively gain access to the control means 20, 22, 23 for any maintenance operations.

The side plates 26 are also provided with ribs 26″ for heat dissipation on their outer surfaces, so as to limit the temperature inside the housing 26′ of the control means 20,22,23.

The screw-nut mechanism 23 comprises a screw 28, preferentially of the reversible multi-start type, having one end rotatingly supported by the supporting frame 24, which is disengageably coupled with a nut screw 29, preferentially made of a technopolymer, connected with the aforesaid thrust member 18; the reversibility of the screw 28 increases the intrinsic safety of the actuator 10, in that it enables it to be operated also in the event of malfunctioning of the electric motor 20.

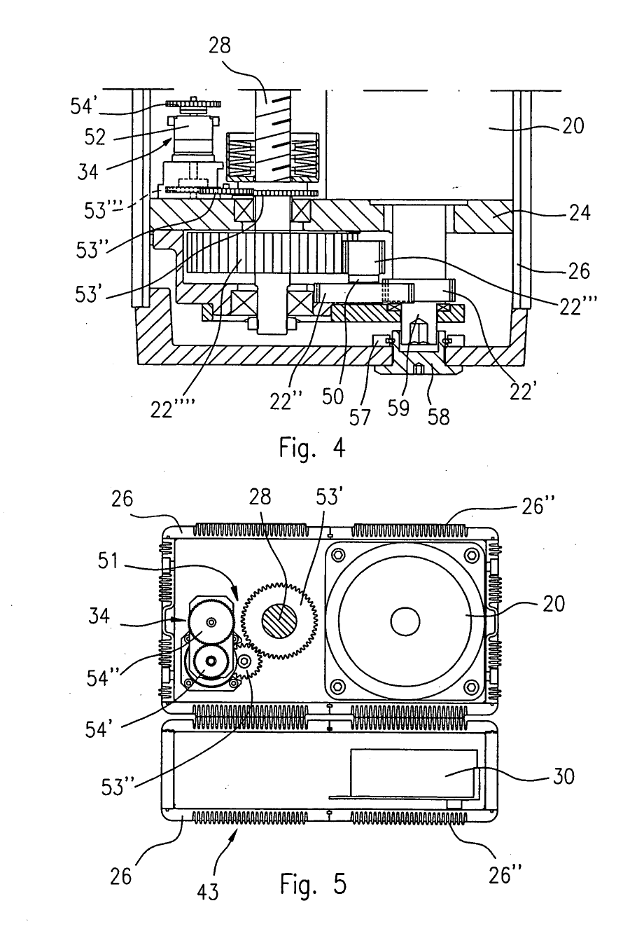

As shown in FIG. 5, the electrically operated actuator 10 also comprises a programmable electronic control unit 30 for controlling the electric motor 20 of the control means, which can be programmed to actuate the control means of the actuator 10 according to pre-established parameters of speed and acceleration of the rocking arm 13, in relation to the angular position and the load applied to the same rocking arm 13.

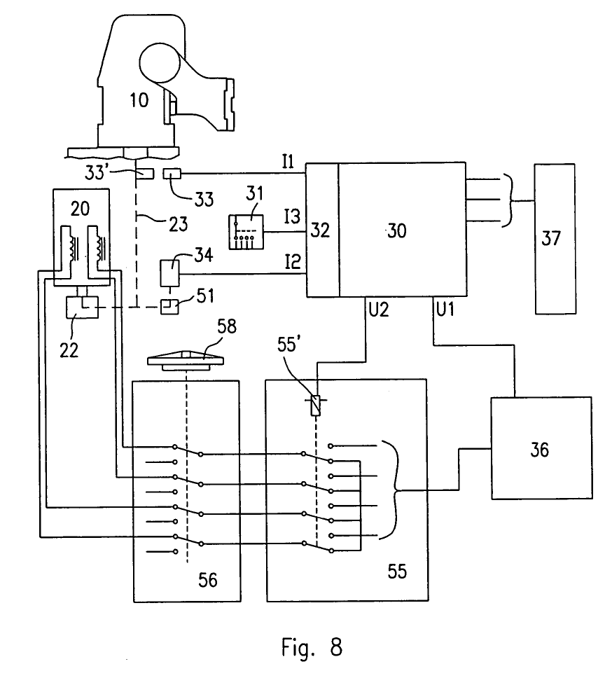

Preferentially, the operation of the actuator 10 can be preset by means of a selectable switch device 31, shown in FIG. 8, for programming the electronic control unit 30, which can be actuated by an operator.

In order to allow an optimal control of the motion parameters of the rocking arm 13, the actuator 10 comprises detecting means for detecting the position, speed and acceleration of the rocking arm 13, which are operatively connected with the electronic control unit 30 by means of a suitable interface 32, as shown in the block diagram of FIG. 8.

The detecting means in particular comprise a detecting sensor 33 for sensing the position of the thrust member 18, the sensor 33 being supported by the base frame 25 connected to the box-shaped body 11, inside the housing 26′ of the control means 20,22,23; said sensor 33 allows to detect the stroke end position of the thrust member 18, in correspondence with an operative position of the rocking arm 13, in particular detecting the position of a locating lug 33′ connected to the thrust member 18.

Preferentially, the detecting sensor 33 is of the optical type, which has proved to be more accurate, in that it is insensitive to magnetic fields and to the presence of metallic masses.

The detecting means also comprise a position transducer device 34 of the rotary and absolute type, having a pre-established operative stroke, operatively connected to the axis of the screw 28 of the screw-nut mechanism 23; said absolute position transducer device 34 is conformed to provide reference signals univocally related to the angular positions of the rocking arm 13.

This is achieved in that the screw-nut mechanism 23 is operatively connected to the position transducer device 34 by a second gear transmission unit 51, shown in FIGS. 4, 5 and 7, conformed to provide a univocal relation between the angular positions of the rotary transducer device 34 and the rocking arm 13.

In particular, the second gear unit 51 has such a high gear reduction ratio that an angular rotation of the position transducer 34 along its entire operative stroke, which is less than 360°, corresponds to the full rocking movement of the arm 13, equivalent to the full extension of the screw-nut mechanism 23.

The use of an absolute position transducer 34 thus allows to always establish the exact position of the rocking arm 13, in relation to the univocal signal detected by the same transducer 34, also in the event of interruptions of the power lines or black-outs, consequently allowing the regular functioning of the production lines to be quickly restored.

The position transducer 34 is preferentially of the potentiometric type, which, compared to a normal absolute encoder, has more limited costs and dimensions.

The second gear unit 51 between the screw-nut mechanism 23 and the position transducer 34 preferentially comprises an epicyclic reduction unit 52 operatively connected with the screw-nut mechanism 23 by means of a first gear reduction set 53; in turn the epicyclic reduction unit 52 is operatively connected with the position transducer 34 by means of a second gear reduction set 54.

In particular, the first gear set 53 comprises for example a first gear 53′ connected to the screw 28, which engages with a second intermediate gear 53″, in turn engaging with a third gear 53′″ connected to one side of the epicyclic reduction unit 52.

The second gear set 54 instead comprises a first gear 54′ connected to the other side of the epicyclic reduction unit 52, which engages with a second gear 54″ connected with the position transducer 34.

As shown in FIG. 8, the actuator 10 is operated and controlled by a system comprising a feeding circuit 36, connected to a power supply line, not shown, and to the control unit 30 of the actuator 10, via an output U1. The feeding circuit 36, in relation to the signals received from the electronic control unit 30, actuates the rotation of the electric motor 20. The control unit 30 of the actuator 10, in turn controlled by a general control system 37 of the plant, guarantees the correct functioning of the actuator 10 in that, as mentioned previously, it is connected with the detecting sensor 33, the position transducer 34 and the charge-over switch 31 by the interface 32, respectively via inputs 11, 12 and 13.

The step electric motor 20 is connected to the feeding circuit 36 by self-braking means comprising short-circuiting switch means 55 for short-circuiting of the electric motor 20, said short-circuiting switch means 55 being controlled by the electronic control unit 30 via an output U2.

The control unit 30 is programmed to control the angular rotation of the rocking arm 13 and to actuate the self braking means 55 for the electric motor 20, in relation to the control signals provided by the absolute transducer device 34.

The electric motor 20 in this way can perform a braking action capable of maintaining the rocking arm 13 blocked in correspondence with any operative position, according to the requirements of the production lines.

Said short-circuiting switch means 55 preferentially comprises a relay 55, capable of short-circuiting on themselves the windings of the electric motor 20, so as to induce a braking action in the motor 20 itself.

Between the step motor 20 and the short-circuiting switch means 55, a disconnecting switch means 56 is also provided for disconnecting the electrical connection of the step motor 20 itself; said disconnecting switch means 56 consists for example of a multiple switch device capable of disconnecting the windings of the motor 20 from the power supply line.

The disconnecting switch means 56 enables the manual operation of the electrically operated actuator 10, in that the motor 20 is disconnected from the power supply line downstream of the short-circuiting switch means 55, and is consequently no longer short-circuited and thus free to rotate.

The disconnecting switch means 56 can be operated manually, for example by means of suitable microswitches 57 operated by removing a suitable cap 58 covering a hub 59 connected to the drive shaft 21, having a slot for insertion of the key for manual operation of the actuator 10.

The correct positioning of the rocking arm 13 in correspondence with the first operative position can be visually checked by an operator in that the rocking arm 13 is provided with a checking element 13′ connected to the same arm 13, which reveals any possible irregular positioning of the arm 13 with respect to a shoulder surf ace 11′ on the box-shaped body 11.

The electronic control unit 30 is disposed inside an external box 43, composed for example of a plurality of connecting plates 26 of a type similar to those of the housing 26′ for the control means, which is secured to a side wall of the control means housing 26′; in this way the electronic control unit 30 is protected from any external electromagnetic fields, which could jeopardise its regular functioning, and is not subjected to increases in temperature caused by the electric motor 20, since they are in two separate environments.

Moreover, in the event of the electrically operated actuator 10 being remote controlled by means of a general plant power unit, it is possible to remove the external box 43, thereby gaining useful space.

The actuator 10 comprises damping means, in particular counter springs 38 for counteracting the thrust member 18 in correspondence with the contracted condition of the screw-nut mechanism 23, which, for example in the form of Bellville washers, are supported by the supporting frame 24 of the control means in correspondence with the end of the screw 28 which engages with the frame 24, in order to limit the mechanical stresses exerted on the actuator 10 when the screw-nut mechanism 23 reaches the aforesaid contracted condition.

The actuator 10 also comprises inside the box-shaped body 11 a stroke-end bumper 60 for the thrust member 18, shaped and disposed to come into contact with the guide rollers 18′ of the thrust member 18 in correspondence with the forward position of the thrust member 18, in such a way as to reduce the stresses on the internal members of the actuator 10, by preventing it from striking against the box-shaped body 11.

From the above, it is evident that an electrically operated actuator 10 according to the invention allows a precise control of the position and of the movement of the rocking arm 13, being also free from parasitic vibrations and oscillations of the working arm 13 itself.

Moreover, said electrically operated actuator 10 is structurally simple and offers the possibility of limiting the plant costs and complexity, in that for its functioning, it requires only an electric power input.

Another advantage is that the limited noise and total absence of polluting substances emissions of the electrical-type control means contribute in improving the quality of the work environment.

Furthermore, an electrically operated actuator 10 of this kind has limited overall costs, due primarily to the absence of additional braking devices and due to the use of a potentiometric type absolute position transducer, which is economical, while possessing good operating characteristics.

What has been described and shown with reference to the accompanying drawings, has been given purely by way of example in order to illustrate the general features of the invention, as well as one of its preferential embodiment; therefore other modifications and variations to the electrically operated actuator provided with rocking arm are possible, without thereby deviating from the scope of the claims.

1. An electrically operated actuator having a rocking arm for operating an angularly movable supporting structure for a plurality of clamping and/or centering devices, the actuator comprising:
a box-shaped body;
at least one angularly movable rocking arm, pivotally supported by said box-shaped body; and
control means having a toggle-lever mechanism operatively connected to the rocking arm;
said linear control means comprising:
at least one electric motor;
a screw-nut mechanism operatively connected between the toggle-lever mechanism and the electric motor; and
a position transducer device of rotary and absolute type, operatively connected to said screw-nut mechanism, said transducer device being conformed to provide reference signals univocally related to angular positions of the rocking arm;
programmable electronic control unit and self-braking means for the electric motor being provided, said control unit being programmed to control the angular rotation of the rocking arm and to actuate the self-braking means for the electric motor, in relation to the control signals provided by the absolute transducer device.

2. Electrically operated actuator according to claim 1, in which the electric motor has a drive shaft, comprising a first gear unit between the drive shaft of the electric motor and said screw-nut mechanism.

3. Electrically operated actuator according to claim 1, comprising a second gear unit between the transducer device and the screw-nut mechanism, the second gear unit being conformed to provide an univocal relation between the angular positions of the rotary transducer and the rocking arm.

4. Electrically operated actuator according to claim 1, wherein said absolute position transducer is of the potentiometric type.

5. Electrically operated actuator according to claim 1, wherein said electric motor is of the step type.

6. Electrically operated actuator according to claim 2, wherein said first gear unit has a gear reduction ratio comprised between 1/5 and 1/9.

7. Electrically operated actuator according to claim 3, wherein said second gear unit comprises an epicyclic reduction unit.

8. Electrically operated actuator according to claim 7, wherein said second gear unit comprises a first and a second gear reduction sets, respectively between said screw-nut mechanism and the epicyclic reduction unit, and between the epicyclic reduction unit and the transducer device.

9. Electrically operated actuator according to claim 1, wherein the control means and the electric motor are secured to a removable support frame, said supporting frame being in turn removably secured to a base frame at the bottom of the box-shaped body, by a plurality of removable side plates extending between the support frame and the base frame.

10. Electrically operated actuator according to claim 1, wherein said electronic control unit is programmable to actuate said electric motor of the actuator according to pre-established speed and acceleration parameters of the rocking arm, in relation to the angular position and a load connected to the same rocking arm.

11. Electrically operated actuator according to claim 1, comprising disconnecting switch means for disconnecting the electrical connections of the electric motor.

12. Electrically operated actuator according to claim 1, comprising a selectable switch device for the electronic control unit.

13. Electrically operated actuator according to claim 1, wherein said toggle-lever mechanism comprises an elastically yieldable connecting link provided with spaced apart stop means arranged to limit the axial compression of the connecting link.

14. Electrically operated actuator according to claim 9, in which said removable side plates extending between the base frame and the support frame define a housing for the control means, wherein said electronic control unit is disposed in a box positioned on a side wall of said housing for the control means.

15. Electrically operated actuator according to claim 9, wherein said side plates are provided with ribs for heat dissipation, on their outer surfaces.

16. Electrically operated actuator according to claim 1, wherein said screw-nut mechanism is of reversible multi-start type.

17. Electrically operated actuator according to claims 9, in which the screw-nut mechanism comprises an axially sliding thrust member operatively connected with the toggle-lever mechanism, the thrust member being movable between a backward and a forward position, comprising damping means arranged on said support frame to contact the thrust member at the backward position of the same thrust member.

18. Electrically operated actuator according to claim 1, in which the screw-nut mechanism comprises an axially sliding thrust member movable between a backward and a forward position, the thrust member being provided with sliding guide rollers movable along the box-shaped body of the actuator, comprising a stroke-end bumper device inside the box-shaped body, said stroke-end bumper being disposed to contact the guide rollers at the forward position of the same thrust member.
